(19) United States
(12) Patent Application Publication
(10) Pub. No.: US 2013/0258920 A1
(43) Pub. Date: Oct. 3, 2013

(54) METHOD OF REDUCING ENERGY CONSUMPTION OF A WIRELESS SENSOR NETWORK

(71) Applicants: Jiun-Huei HO, Kaohsiung City (TW); Rong-Ching WU, Kaohsiung City (TW); Chun-Wei TSENG, Kaohsiung City (TW); Chiung-Chang SHIEH, Kaohsiung City (TW); Hong-Chi SHIH, Kaohsiung City (TW)

(72) Inventors: Jiun-Huei HO, Kaohsiung City (TW); Rong-Ching WU, Kaohsiung City (TW); Chun-Wei TSENG, Kaohsiung City (TW); Chiung-Chang SHIEH, Kaohsiung City (TW); Hong-Chi SHIH, Kaohsiung City (TW)

(73) Assignee: I SHOU UNIVERSITY, Kaohsiung City (TW)

(21) Appl. No.: 13/435,359

(22) Filed: Mar. 30, 2012

(51) Int. Cl. H04W 52/02; H04W 40/24

(52) U.S. Cl. 370/311

(57) ABSTRACT

A method of reducing energy consumption is to be performed by a network node, and includes configuring the network node to perform the consecutive steps of: b1) setting an initial value for each of first and second parameters; b2) skipping to step b5) if the second parameter is smaller than a random value; b3) estimating an amount of energy required for, and computing a probability of, data transmission therefrom; b4) selecting one of other network nodes corresponding to a greatest value of the first parameter for serving as a transmission route; b5) determining whether data transmitted thereby has reached a destination network node, and skipping to step b7) if affirmative; b6) updating the first parameters of the other network nodes, and returning to step b2); and b7) updating the first parameters of the network nodes belonging to an optimal route.

### BACKGROUND OF THE INVENTION

1. Field of the Invention

The present invention relates to a method of reducing energy consumption, more particularly to a method of reducing energy consumption of a wireless sensor network.

2. Description of the Related Art

As wireless sensor technologies advance, wireless sensor networks have been employed in various applications, such as military monitoring, environment monitoring, and household health inspection. However, since most wireless sensor devices are powered by batteries, routing of data packets through a network established thereamong may fail due to insufficient power. To alleviate this problem, C. E. Perkins et al. proposed “Ad-hoc On-Demand Distance Vector (AODV) Routing” in IEEE WMCSA (1999), which is a routing protocol for wireless ad-hoc networks. Each node in an AODV-based network stores therein a routing table. Each entry in the routing table includes routing information corresponding to one of the other nodes.

When the routing table of a source node includes routing information corresponding to a destination node, the source node may simply forward data packets to the destination node according to the routing information. However, if routing information corresponding to a destination node is not found in the routing table of a source node, the source node must perform a route discovery process, which may be time- and energy-consuming, in order to acquire the needed routing information. Moreover, since the routing table of each node generally holds incomprehensive routing information corresponding to only a small portion of the nodes of the entire network, each of the nodes may have to perform the node discovery process frequently, which may render the ad-hoc network inefficient in terms of performance and energy consumption.

### SUMMARY OF THE INVENTION

Therefore, an object of the present invention is to provide a method of reducing energy consumption of a wireless sensor network.

According to the present invention, a method of reducing energy consumption of a wireless sensor network is to be performed by a plurality of network nodes of the wireless sensor network. Each of the network nodes is capable of information processing and wireless communication and has obtained routing information corresponding to one another. The method includes the steps of:

b1) configuring one of the network nodes to set an initial value for each of first, second, and third parameters, and to proceed to step b2);

b2) configuring said one of the network nodes to generate a first random value having a predetermined range, and to proceed to step b3) if the first random value is greater than the second parameter, and to step b5) if otherwise;

b3) configuring said one of the network nodes to perform an estimation of an amount of energy required by said one of the network nodes for sending data according to a predetermined fitness function, and to proceed to step b4);

b4) configuring said one of the network nodes to compute a probability of data transmission from said one of the network nodes to each of remaining ones of the network nodes according to a predetermined transmission probability relation, and to proceed to step b5);

b5) configuring said one of the network nodes to select one of the remaining ones of the network nodes that corresponds to a greatest value of the first parameter for serving as a transmission route according to a predetermined node selection relation, and to proceed to step b6);

b6) configuring said one of the network nodes to determine whether data transmitted thereby has reached a destination network node, and to proceed to step b8) if affirmative, and to step b7) if otherwise;

b7) configuring said one of the network nodes to update the first parameter of each of the remaining ones of the network nodes according to a first predetermined update relation, and to proceed back to step b2); and

b8) configuring said one of the network nodes to update the first parameters corresponding to the network nodes that belong to an optimal route according to a second predetermined update relation.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart to illustrate first and second phases of the preferred embodiment of a method of reducing energy consumption of a wireless sensor network according to the present invention;

FIG. 2 is a flowchart to illustrate steps of the first phase;

FIG. 3 is a diagram to illustrate an exemplary wireless sensor network; and

FIG. 4 is a flowchart to illustrate steps of the second phase.

### DETAILED DESCRIPTION OF THE PREFERRED EMBODIMENT

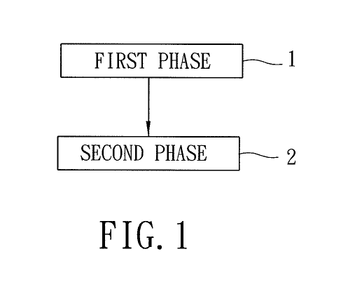

Referring to FIG. 1, the preferred embodiment of a method of reducing energy consumption of a wireless sensor network, which is established among a plurality of network nodes capable of information processing and wireless communication, may be divided into first and second phases, according to the present invention.

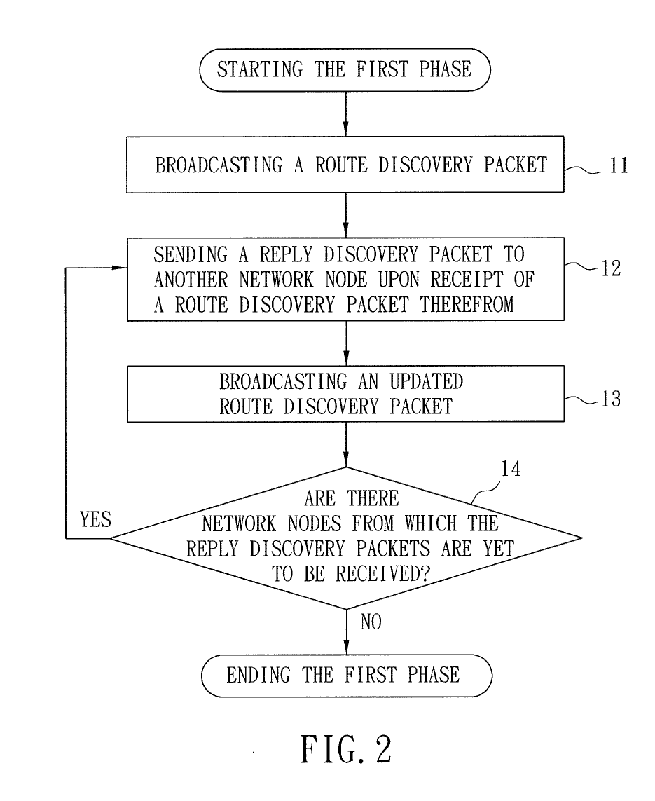

Referring to FIG. 2, the first phase includes steps 11 to 14.

In step 11, each of the network nodes is configured to broadcast a route discovery packet to nearby network nodes within a communication range thereof in an attempt to discover at least one route to each of the other network nodes, and to subsequently proceed to step 12.

In step 12, each of the network nodes is configured to, upon receipt of the route discovery packet, send a reply discovery packet to the nearby network node from which the route discovery packet is received, and to proceed to step 13.

In step 13, each of the network nodes is configured to update the route discovery packet received thereby to generate an updated route discovery packet, and to broadcast the updated route discovery packet to the nearby network nodes, and to proceed to step 14. It is to be noted that the updated route discovery packet thus generated is not sent to the network node from which the route discovery packet corresponding to the updated route discovery packet was received.

In step 14, each of the network nodes is configured to determine whether there are network nodes from which the reply discovery packets are yet to be received according to a predetermined condition, which may be based on elapsed time, and to proceed back to step 12 if affirmative, and to end the first phase if otherwise.

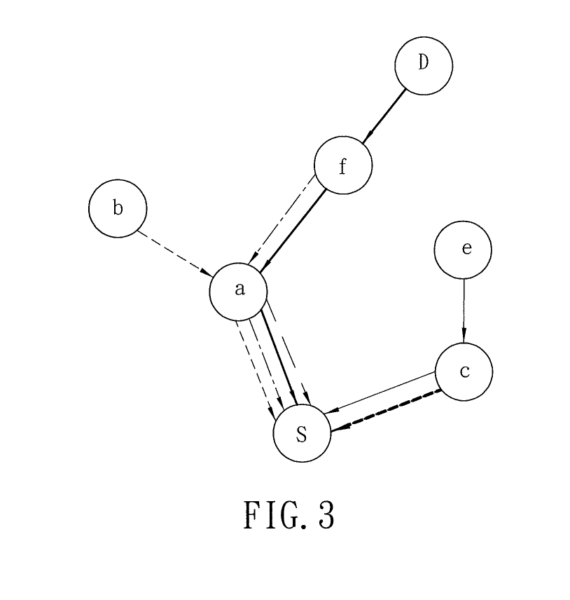

Performing of steps 11 to 14 will hereinafter be described in connection with an exemplary network illustrated in FIG. 3, in which source node “S” attempts to discover a route to destination node “D” via a portion of intermediate nodes “a”, “b”, “c”, “e”, and “f”.

Source node “S” transmits a level-1 route discovery packet to intermediate nodes “a” and “c” (step 11). Each of intermediate nodes “a” and “c” sends a route reply packet to source node “S” upon receipt of the level-1 route discovery packet (step 12), and updates the route discovery packet received thereby so as to generate a level-2 route discovery packet (step 13). Intermediate node “a” sends the level-2 route discovery packet generated thereby to intermediate nodes “b” and “f” (step 13). Intermediate node “c” sends the level-2 route discovery packet generated thereby to intermediate node “e” (step 13). Subsequently, each of intermediate nodes “b” and “f” sends a route reply packet to intermediate node “a” upon receipt of the level-2 route discovery packet from the same (step 12), and updates the level-2 route discovery packet so as to generate a level-3 route discovery packet (step 13). On the other hand, intermediate node “e” sends a route reply packet to intermediate node “c” upon receipt of the level-2 route discovery packet from the same (step 12). Since all of the intermediate nodes with which intermediates nodes “b” and “e” may communicate have received the respective route discovery packets, each of intermediates nodes “b” and “e” does not further send respective route discovery messages. Finally, intermediate node “f” sends the level-3 route discovery packet to destination node “D” (step 13), which then sends a route reply packet to intermediate node “f” upon receipt of the level-3 route discovery packet from the same (step 12). This route reply packet from destination node “D” is forwarded back to source node “S” along intermediate nodes “f” and “a”.

After a predetermined time has elapsed, source node “S” determines that there is no more network node from which the route reply packet is to be received (step 14), and ends the first phase to proceed to the second phase.

When the first phase is determined to have ended, each of the network nodes preferably has obtained routing information represented by the routing table shown in Table 1, and is ready to proceed to the second phase.

TABLE 1

| Source | Destination | Next node |
|---|---|---|
| a | S | S |
| b | S | a |
| c | S | S |
| D | S | f |
| e | S | C |
| f | S | a |

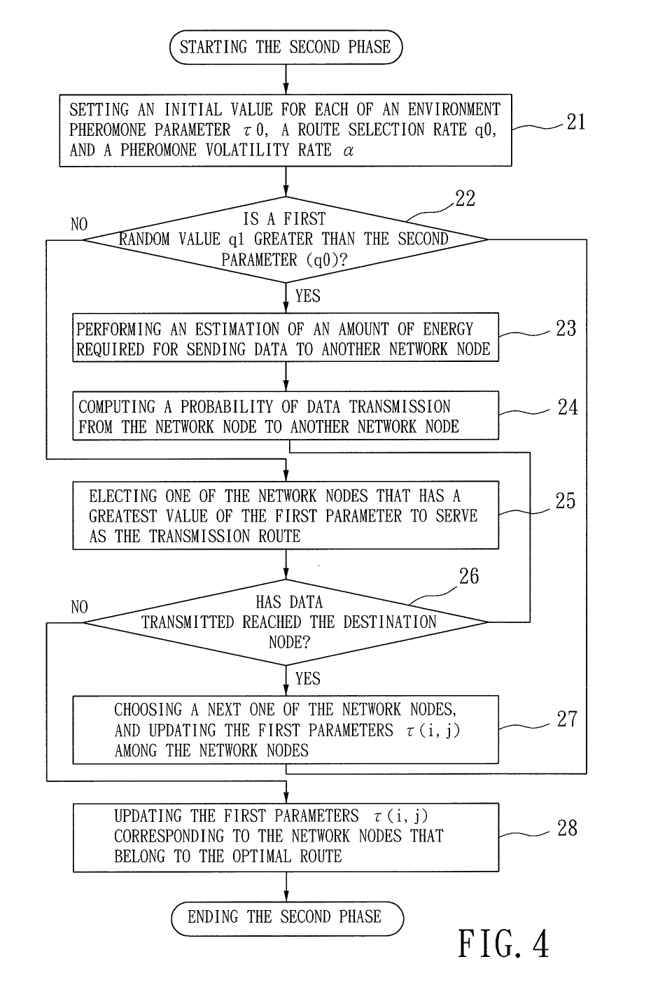

Referring to FIG. 4, the second phase includes steps 21 to 28, and is based on a modification to an ant colony optimization algorithm proposed by M. Dorigo et al. in “Ant colony system: a cooperative learning approach to the traveling salesman problem” in IEEE trans. (1997).

In step 21, each of the network nodes is configured to set an initial value for each of an environment pheromone parameter τ₀ (hereinafter referred to as the first parameter), a route selection rate q₀ (hereinafter referred to as the second parameter), and a pheromone volatility rate a (hereinafter referred to as the third parameter), and to proceed to step 22. In this embodiment, each of the first, second, and third parameters has a value ranging from 0 to 1.

In step 22, each of the network nodes is configured to generate a first random value q₁ having a predetermined range, and to proceed to step 23 if the first random value q₁ is greater than the second parameter (q₀), and to step 25 if otherwise.

In step 23, each of the network nodes is configured to perform an estimation of an amount of energy required for sending data to another network node according to the fitness function of

P_{(i,j)}(r,d)=r(α₁+α₂d_{(i,j)}ⁿ)+Nⱼ

where P_{(i,j)}(r,d) represents an amount of energy required for sending data from an i^{th} network node to a j^{th} network node, r represents a rate of data transmission, d represents a Euclidean distance between the i^{th} and j^{th} network nodes, α₁ represents a non-distance factor coefficient, α₂ represents a distance factor coefficient, and Nⱼ represents an amount of consumed energy of the j^{th} network node.

Next, in step 24, each of the network nodes is configured to compute a probability of data transmission from the network node to another network node according to a predetermined transmission probability relation (formula (F.2)) and corresponding adaption functions thereof

$${U}_{k} ( i , j ) = \{ \begin{matrix}\frac{τ ( i , j ) \cdot Δ {P}_{( i , j )}^{β}}{{\sum }_{u ∈ {J}_{k} ( r )} τ ( i , j ) \cdot Δ {P}_{( i , j )}^{β}} , & if s ∈ {J}_{k} ( i ) \\ 0 , & if s ∉ {J}_{k} ( i )\end{matrix} \qquad ( F .2 )$$

where Uₖ(i,j) is the probability of data transmission, ΔP(_{i,j}) represents a change in amount of energy consumption attributed to the data transmission from the i^{th} network node to the j^{th} network node, Jₖ(i) represents an aggregation of other network nodes corresponding to the routing table of an i^{th} network node of a k^{th} transmission route, τ(i,j) represents a value of the first parameter corresponding to the i^{th} network node and the j^{th} network node, and β is an evaluation parameter.

Subsequently, each of the network nodes is further configured to select one of the transmission routes according to the corresponding probabilities of data transmission with reference to a second random number value, and to proceed to step 26.

In step 25, each of the network nodes is configured to select one of the network nodes that has a greatest value of the first parameter to serve as the transmission route according to a node selection relation (formula (F.3)), and to proceed to step 26.

$$s = \{ \begin{matrix}arg \{ {max}_{u ∈ {J}_{k} ( r )} [ τ ( r , u ) \cdot ( \frac{1}{{P}_{( i , j )} ( r , s )} {}^{β} ) ] \} & if {q}_{1} \leq {q}_{0} \\ S , & if {q}_{1} > {q}_{0}\end{matrix} \qquad ( F .3 )$$

In step 26, each of the network nodes is configured to determine whether data transmitted thereby has reached the destination node, and to proceed to step 28 if affirmative, and to step 27 if otherwise.

In step 27, each of the network nodes is configured to choose a next one of the network nodes, to update the first parameters τ(i,j) among the network nodes according to a first predetermined update relation (formula (F.4)), and to subsequently proceed back to step 22.

τ(i,j)=(1−ρ)·τ(i,j)+ρ·ΔP_{(i,j)} (F.4)

where ΔP_{(i,j)} is equal to (n*P_{(i,j)}(r,s))⁻¹, n represents an n^{th} network node, and ρ represents a volatility rate of the first parameters τ(i,j), which ranges from 0 to 1, for controlling a residual amount of the first parameters τ(i,j) that increases when the network node is chosen and that decreases when otherwise.

In step 28, each of the network nodes is configured to update the first parameters τ(i,j) corresponding to the network nodes that belong to the optimal route, which is an aggregation of the network nodes acquired through performing steps 22 to 27, according to a second predetermined update relation (formula (F.5)).

τ(i,j)=(1−α)·τ(i,j)+αΣᵢ₌₁^{m-1}ΔP_{(i,j)} (F.5)

where ΔP_{(i,j)} is equal to (n*P_{(i,j)}(r,s))⁻¹, m represents the aggregation of the network nodes in the optimal route, and n represents an n^{th} network node identical to the optimal route.

In summary, the method of reducing energy consumption of a wireless sensor network, according to the present invention, reduces the amount of times of data transmissions among the network nodes, and hence reduces energy consumption of the network nodes. In addition, in the second phase, an optimal route is selected for data transmission while remaining ones of unused network nodes may serve as backup for failover in the case where one or more of the network nodes of the optimal route fail due to malfunction or insufficient energy, thereby eliminating the need to discover an alternative transmission route and hence reducing overall energy consumption of the network.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of reducing energy consumption of a wireless sensor network, said method to be performed by a plurality of network nodes of the wireless sensor network, each of the network nodes being capable of information processing and wireless communication and having obtained routing information corresponding to one another, said method comprising the steps of:
b1) configuring one of the network nodes to set an initial value for each of first, second, and third parameters, and to proceed to step b2);
b2) configuring said one of the network nodes to generate a first random value having a predetermined range, and to proceed to step b3) if the first random value is greater than the second parameter, and to step b5) if otherwise;
b3) configuring said one of the network nodes to perform an estimation of an amount of energy required by said one of the network nodes for sending data according to a predetermined fitness function, and to proceed to step b4);
b4) configuring said one of the network nodes to compute a probability of data transmission from said one of the network nodes to each of remaining ones of the network nodes according to a predetermined transmission probability relation, and to proceed to step b5);
b5) configuring said one of the network nodes to select one of the remaining ones of the network nodes that corresponds to a greatest value of the first parameter for serving as a transmission route according to a predetermined node selection relation, and to proceed to step b6);
b6) configuring said one of the network nodes to determine whether data transmitted thereby has reached a destination network node, and to proceed to step b8) if affirmative, and to step b7) if otherwise;
b7) configuring said one of the network nodes to update the first parameter of each of the remaining ones of the network nodes according to a first predetermined update relation, and to proceed back to step b2); and
b8) configuring said one of the network nodes to update the first parameters corresponding to the network nodes that belong to an optimal route according to a second predetermined update relation.

2. The method as claimed in claim 1, wherein the predetermined fitness function is
P_{(i,j)}(r,d)=r(α₁+α₂d_{(i,j)}ⁿ)+Nⱼ
where P_{(i,j)}(r,d) represents an amount of energy required for sending data from an i^{th} network node to a j^{th} network node, r represents a rate of data transmission, d represents a Euclidean distance between the i^{th} and j^{th} network nodes, α₁ represents a non-distance factor coefficient, α₂ represents a distance factor coefficient, and Nⱼ represents an amount of consumed energy of the j^{th} network node.

3. The method as claimed in claim 1, wherein the predetermined transmission probability relation is
$${U}_{k} ( i , j ) = \{ \begin{matrix}\frac{τ ( i , j ) \cdot Δ {P}_{( i , j )}^{β}}{{\sum }_{u ∈ {J}_{k} ( r )} τ ( i , j ) \cdot Δ {P}_{( i , j )}^{β}} , & if s ∈ {J}_{k} ( i ) \\ 0 , & if s ∉ {J}_{k} ( i )\end{matrix}$$
where Uₖ(i,j) is the probability of data transmission, ΔP_{(i,j)} represents a change in amount of energy consumption attributed to the data transmission from the i^{th} network node to the j^{th} network node, Jₖ (i) represents an aggregation of other network nodes of an i^{th} network node of a k^{th} transmission route, τ(i,j) represents a value of the first parameter of the i^{th} network node and the j^{th} network node, and β is an evaluation parameter.

4. The method as claimed in claim 1, wherein the first predetermined node update relation is
τ(i,j)=(1−ρ)·τ(i,j)+ρΔP_{(i,j)}
where ΔP_{(i,j)} is equal to (n*P_{(i,j)}(r,s))⁻¹, n represents an n^{th} network node, and ρ represents a volatility rate of the first parameters τ(i,j), which ranges from 0 to 1, for controlling a residual amount of the first parameters τ(i,j) that increases when the network node is chosen and that decreases when otherwise.

5. The method as claimed in claim 1, wherein the second predetermined node update relation is
τ(i,j)=(1−α)·(i,j)+αΣᵢ₌₁^{m-1}ΔP_{(i,j)}
where ΔP_{(i,j)} is equal to (n*P_{(i,j)}(r,s))⁻¹, m represents the aggregation of the network nodes in the optimal route, and n represents an n^{th} network node identical to the optimal route.

6. The method as claimed in claim 1, wherein each of the first, second, and third parameters has a value ranging from 0 to 1.

7. The method as claimed in claim 1, further comprising, prior to step b1), the steps of:
a1) configuring one of the network nodes to broadcast a route discovery packet to a nearby one of the network nodes within a communication range of said one of the network nodes;
a2) configuring the nearby one of the network nodes to, upon receipt of the route discovery packet, send a reply discovery packet for receipt by said one of the network nodes;
a3) configuring the nearby one of the network nodes to update the route discovery packet received thereby so as to generate an updated route discovery packet, and to broadcast the updated route discovery packet to a portion of remaining ones of the network nodes; and
a4) configuring said one of the network nodes to determine whether there are network nodes from which the reply discovery packets are yet to be received according to a predetermined condition, and to proceed back to step a1) if affirmative, and to step b1) if otherwise.

8. The method as claimed in claim 7, wherein, in step a4), said one of the network nodes is configured to determine that there is no network node from which the reply discovery packet is yet to be received and to proceed to step b1) if a predetermined time period has elapsed.
